(19) United States
(12) Patent Application Publication
(10) Pub. No.: US 2002/0026870 A1
(43) Pub. Date: Mar. 7, 2002

(54) Hydraulic device

(76) Inventor: Fernando Nesi, Brussels (BE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/910,868

(22) Filed: Jul. 24, 2001

(30) Foreign Application Priority Data
Jul. 26, 2000 (EP) 00870170.8

(51) Int. Cl. F15B 11/00

(52) U.S. Cl. 91/519

(57) ABSTRACT

Hydraulic device comprising two hydraulic actuators (1, 2), in particular a motor (2) and a double-acting jack (1), each comprising two couplings (1a, 1b, 2a, 2b) for the entry and/or the exit of a control fluid, two pipes (6, 7) coupled to the two actuators (1, 2) and devised so that one conveys a pressurized fluid to a coupling of each actuator whilst the other discharges the fluid to the other coupling, and vice versa, in such a way that the jack (1) can be controlled in respect of [lacuna] a movement in one direction and in the reverse direction, and a reversing gate for reversing between the two pipes (6, 7) the supplying of pressurized fluid and the discharging of the fluid, so as to control the direction of the movement of the said jack (1), the device furthermore comprising: a means of detection (8) of a difference in pressure between the pressurized fluid and the discharged fluid, and between the reversing gate and the other actuator (2), an auxiliary reversing means (9), devised so as to receive a command from the detection means (8) and to couple, according to this command, the pipe (6, 7) supplied with pressurized fluid to a same coupling (2a) of the other actuator (2).

The present invention relates to a hydraulic device comprising two hydraulic actuators, in particular a motor and a double-acting jack, each comprising two couplings for the entry and/or the exit of a control fluid. Two pipes are coupled to the two actuators and devised so that one conveys a pressurized fluid to a respective coupling of each actuator whilst the other discharges the fluid to the other respective coupling, and vice versa, in such a way that one of the actuators, in particular the jack, can be controlled so as to selectively produce a movement in one direction as well as in a reverse direction. A selective reversing gate is provided for reversing between the two pipes the supplying of pressurized fluid and the discharging of the fluid, so as to control the direction of the movement of one of the actuators, in particular of the said jack.

A device of the kind can consist of a rig intended in particular for agricultural, civil engineering or military works, in which the reversing gate is a control available to an operator of the rig, for example by way of a lever or of a pedal. In this kind of rig, two pipes are often installed in reserve mode to control an optional accessory which may be mounted at the tip of an articulated arm.

An exemplary case of such an optional accessory is a coring or drilling apparatus which is equipped with a hydraulic motor for rotating a drill bit and with a double-acting hydraulic jack or with another hydraulic motor for imparting to the bit a drilling advancing movement and a retreating movement of the bit.

In this exemplary case, given that only two pipes are available for the accessory, the jack and the motor must be coupled in parallel to them in such a way that, while powering the jack for an advancing movement of the bit, the motor rotates in a drilling direction. Consequently and automatically, upon powering the jack in a direction of retreat of the bit, the motor is caused to rotate in the direction reverse to the drilling direction and this is especially undesirable. The aim of the present invention is to remedy in particular this problem and to provide in this case, as in others not described at present, a simple and effective means which makes it possible, on the one hand, to procure in a known manner the advancing and retreating movement of the jack and, on the other hand, to have the motor of the bit retain the same direction of rotation during both the advancing and retreating movements, without adding further pipe(s) to an existing rig.

Accordingly, the invention consists in equipping the device, at the location of the aforesaid accessory, with a means of detection sensitive to a difference in pressure between the pressurized fluid and the discharged fluid, and placing between the abovementioned reversing gate and the other actuator for which one wishes the fluid to always act in the same direction, in particular the hydraulic motor, an auxiliary reversing means, devised so as to receive a command from the detection means and to automatically couple, as a function of this command, the pipe supplied with pressurized fluid to a same specified coupling of the other actuator, in particular the motor.

In one embodiment of the device according to the invention, the detection means and auxiliary reversing means are combined into a system of four check valves each devised so as to open in one direction and close in the other direction of flow of the fluid. These four valves are then mounted in the manner of a four-diode Graëtz bridge for rectifying an electric current, as explained in detail hereinbelow.

In another embodiment of the invention, the device concerned can comprise, in the guise of detection means, at least one drive gate devised so as to sense the pressure of the pressurized fluid, with respect to that of the discharged fluid, of one of the two pipes, and in the guise of auxiliary reversing means, a gate having two positions, a position for parallel coupling and a position for crossed coupling of the two pipes to the two couplings of the second actuator.

Other details and features of the invention will emerge from the secondary claims and from the description of the drawings which are appended to the present document and which illustrate, by way of nonlimiting examples, particular embodiments of the device according to the invention.

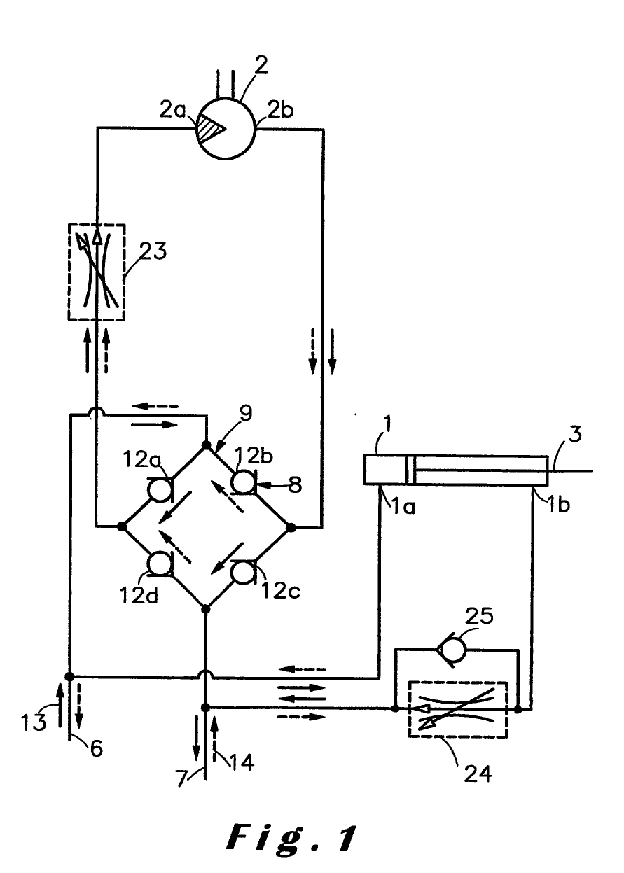

FIG. 1 shows a simplified hydraulic diagram of a first way of connecting up the two actuators and the detection means and auxiliary reversing means of the device according to the invention.

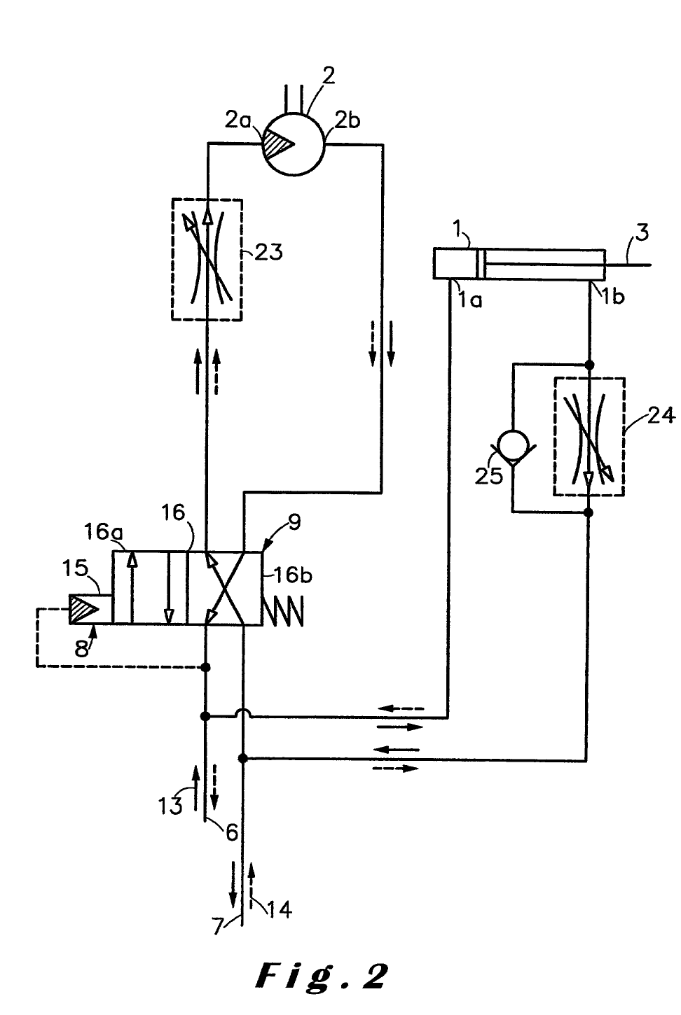

FIGS. 2 to 5 show in the same manner various possible alternative ways of connecting up the two actuators and the detection means and auxiliary reversing means of the device according to the invention.

In the various figures, the same reference notation designates identical or similar elements.

The hydraulic device to which the invention relates can comprise (FIG. 1) at least two hydraulic actuators 1 and 2 each usually comprising two couplings, respectively 1a and 1b for the one and 2a and 2b for the other, for the entry and/or the exit of a control fluid. The actuator 1 can be a double-acting jack 1, the direction of displacement of whose stem 3 must be capable of being reversed, whereas the actuator 2 can be an abovementioned hydraulic motor 2 or, as appropriate, for example a single-acting jack (not represented) whose stem must constantly provide a thrust in the same direction.

Two pipes 6 and 7 are coupled to the two actuators 1 and 2 and are devised so that one conveys a pressurized fluid to a respective coupling of each actuator whilst the other discharges the fluid to the other respective coupling, and vice versa, in such a way that one of the actuators, in particular the jack 1, can be controlled so as to selectively produce a movement in one direction as well as in a reverse direction. A selective reversing gate (not shown) is provided for reversing upstream, between the two pipes 6 and 7, the supplying of pressurized fluid and the discharging of the fluid, so as to control the direction of the movement of the said jack 1.

To achieve the sought-after aim explained hereinabove, the device of the invention comprises at least one means of detection 8 sensitive to a difference in pressure between the pressurized fluid and the discharged fluid, and between the aforesaid reversing gate and the other actuator 2, in this instance the motor 2, an auxiliary reversing means 9, devised so as to receive a command from the detection means 8 and to automatically couple, as a function of this command, the pipe 6, 7 supplied at this moment with pressurized fluid to one and the same specified coupling 2a of the motor 2.

As already stated hereinabove, the detection means 8 and auxiliary reversing means 9 (FIG. 1) may advantageously be combined into a system of four check valves 12 devised so as to open in one direction and close in the other direction of flow of the fluid.

These known valves 12, shown diagrammatically in FIG. 1, can each consist, as is known to the person skilled in the art, of a body which has an entrance orifice and an exit orifice for the hydraulic fluid and in which are placed a ball forming the valve proper and a spring positioning the ball against a valve seat.

In this system, a first valve 12a and a second valve 12b are coupled by one of their orifices to a first of the two pipes, for example the pipe 6: the first valve 12a in a passing direction and the second 12b in a blocking direction for the fluid coming from this first pipe 6. A third valve 12c and a fourth valve 12d are coupled by one of their orifices to the second pipe 7: the third valve 12c in a blocking direction and the fourth valve 12d in a passing direction for the fluid coming from the second pipe 7.

The first and fourth valves 12a, 12d are then coupled by their other respective orifice to a chosen coupling, for example the coupling 2a, of the second actuator or hydraulic motor 2. The second and third valves 12c, 12d are also coupled by their other respective orifice to the other coupling 2b of the second actuator 2.

The person skilled in the art can follow in FIG. 1 the manner of operation of the system of valves 12. Arriving from the reversing gate controlled for example by the operator of the device, the pressurized fluid flows, following the solid arrow 13, through the pipe 6. It thus goes off not only towards the coupling 1a of the jack 1, in order to take the stem 3 out, but also towards the system of valves 12. The valve 12b blocks the passage whilst the valve 12a allows the pressurized fluid to reach the coupling 2a, of the motor 2, corresponding to a drilling direction of rotation for the bit of the exemplary case mentioned above. The valve 12d prevents the pressurized fluid from escaping to the pipe 7 which serves as return pipe. The fluid which leaves the motor 2 via its coupling 2b arrives at the fork of the valve 12b, jammed closed by the pressurized fluid coming from the pipe 6, and of the valve 12c which allows it to escape to the pipe 7 in the guise of discharged fluid.

Following the reversing of the reversing gate by the operator, the pressurized fluid arrives via the pipe 7, following the broken arrow 14. It then goes off towards the coupling 1b of the jack 1 so as to bring the stem 3 back in. At the same time it arrives at the fork towards the valve 12c which blocks its passage and at the valve 12d which allows its passage to the coupling 2a of the motor 2, corresponding to the drilling direction of rotation. The valve 12a prevents the pressurized fluid escaping to the pipe 6 which serves as return pipe. The fluid which leaves the motor 2 via the coupling 2b arrives at the fork of the valve 12c, jammed closed by the pressurized fluid coming from the pipe 7, and of the valve 12b which allows it to escape to the pipe 6 in the guise of discharged fluid. This demonstrates that the sought-after aim is achieved.

In another embodiment of the invention (FIG. 2), the device can comprise, as detection means 8 for sensing the pressure of the pressurized fluid with respect to that of the discharged fluid, at least one drive gate 15 connected up to one of the two pipes, for example the pipe 6 according to the drawing. The auxiliary reversing means can then be a gate 16 having two positions, a position for parallel coupling and a position for crossed coupling of the two pipes 6, 7 to the two couplings 2a and 2b of the motor 2. The symbols of the gate 16 which are represented in the drawings explain its type.

When the drive gate 15 detects in the pipe 6 the pressure of the pressurized fluid greater than that of the discharged fluid, it operates the auxiliary reversing gate 16 so that the latter connects up (position 16a), on the one hand, the pipe 6 and the coupling 2a and, on the other hand, the coupling 2b and the pipe 7 which then serves for discharge. When the drive gate 15 detects in the pipe 6 the pressure of the discharged fluid less than that of the pressurized fluid, it operates the auxiliary reversing gate 16 so that the latter connects up (position 16b), on the one hand, the pipe 7 and the coupling 2a and, on the other hand, the coupling 2b and the pipe 6 which then serves for discharge.

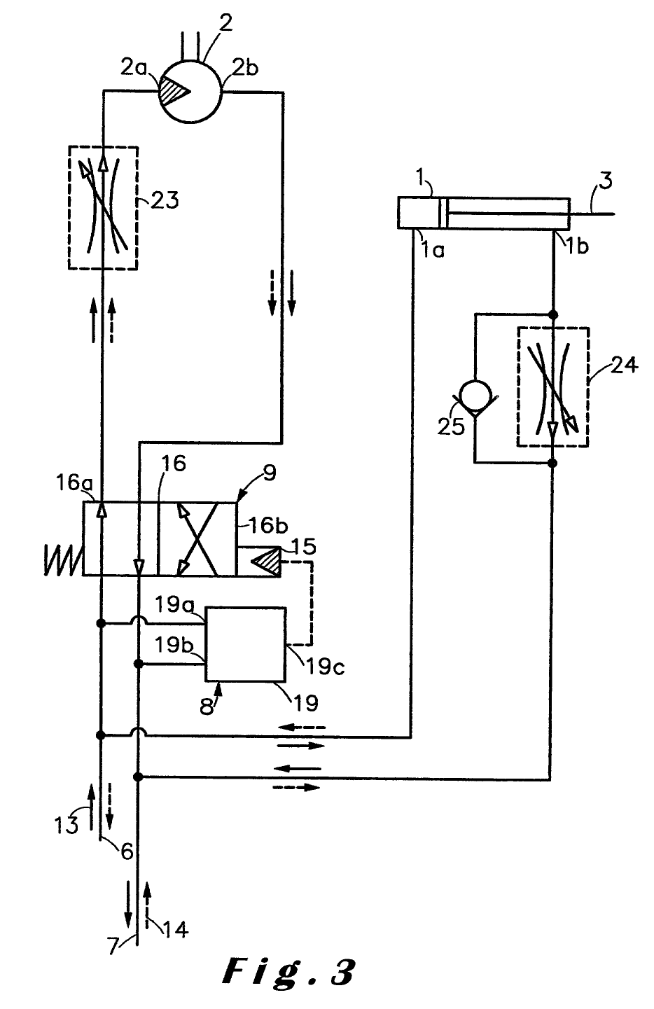

In an alternative embodiment of the invention, the detection means 8 can be (FIG. 3) a pressure comparator 19 having two inputs 19a and 19b for a respective pressure signal and a control output 19c, the input 19a being coupled to the pipe 6 and the input 19b to the pipe 7 so as to sense the respective pressures thereof. The control output 19c is coupled, optionally by way of a drive gate, to a two-position gate 16 similar to that just described, to obtain a manner of operation of the same kind.

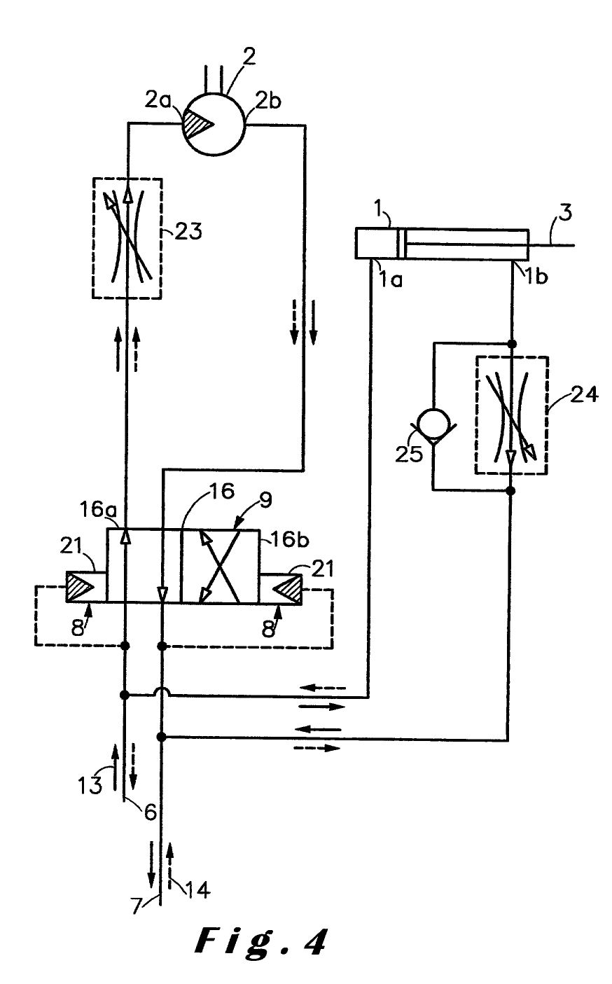

In another alternative embodiment of the invention, the detection means 8 or pressure comparator can be (FIG. 4) formed by two drive gates 21 devised so that each senses the pressure of a respective pipe 6 or 7 of the two aforesaid pipes. The drive gates 21 can operate, also in this case, a two-position gate 16 described hereinabove. However, in this alternative embodiment one could prefer a gate (not represented) comprising a third position in which, when the two drive gates 21 sense a pressure of the same order in their associated pipe, the passage of fluid between the two pipes 6, 7 and the second actuator 2 is blocked so as to preclude any possible abnormal operation of the device.

It should be understood that the invention is in no way limited to the embodiments described and that many modifications may be made to them without departing from the scope of the claims.

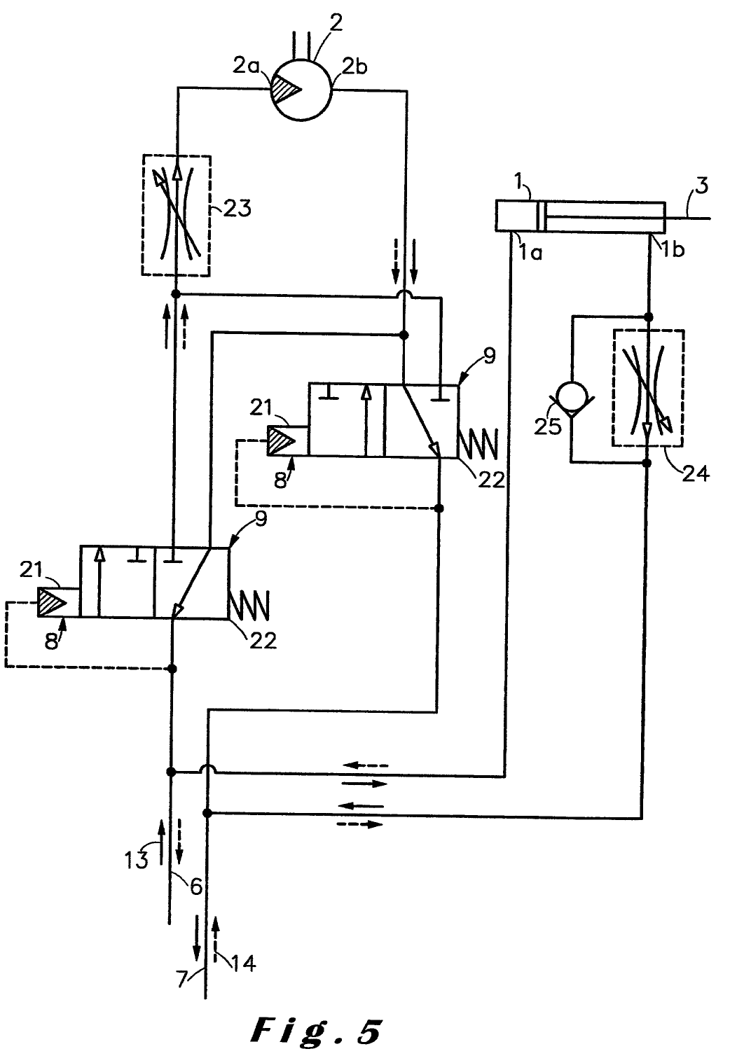

Thus, FIG. 5 represents a nonexhaustive further alternative embodiment of the detection means 8 and auxiliary reversing means 9. The reversing means 9 are constituted therein by two separate gates 22 with two positions, a gate 22 for each pipe 6, 7. Each gate 22 is controlled by an associated drive gate 21 connected up so as to detect in the corresponding pipe 6, 7 the presence of the pressurized fluid or of the discharged fluid and so as to set the appropriate position of the associated gate 22 accordingly. In the setup of FIG. 5, it is apparent that each gate 22 (whose symbols explain the type) supplies, alternately with the other, the motor 2 or alternately allows the discharging of the fluid thereof.

The device of the invention can comprise, in a known manner and with a usual aim, a flow rate regulator 23 placed upstream of the coupling 2a for supplying the motor 2 so as to limit the speed of the latter and to produce an appropriate back pressure so that the jack 1 constantly receives an adequate control pressure in respect of its reciprocating translational movements.

Another flow rate regulator 24 associated in a known manner with a check valve 25 can advantageously be placed upstream of the coupling 1b of the jack 1 (on the stem side) so as to set the speed of displacement of the stem 3 during drilling.

From the foregoing explanations it is clearly apparent that, with the two pipes 6, 7, two distinct functions and movements, namely a rotation in a single direction for the actuator 2 and a reciprocating movement for the actuator 1, are provided for without requiring a hydraulic, pneumatic or electrical auxiliary control source. It is sufficient for the flow rate of hydraulic fluid to be greater than the aggregate flow rates necessary for supplying the two actuators.

It should also be understood within the scope of the claims that two or more actuators 1 may be connected up in parallel, as can two or more actuators 2, in the circuit of any of the figures.

### Key for the Figures

1 Actuator, hydraulic motor

1a, 1b Couplings of 1

2 Actuator, double-acting jack

2a, 2b Couplings of 2

3 Stem of 2

6 Pipe

7 Pipe

8 Detection means

9 Reversing means

12 Valves 12a to 12d

13 Solid arrows

14 Broken arrows

15 Drive gate

16 Two-position gate

16a “Parallel” position of 16

16b “Crossed” position of 16

19 Pressure comparator

19a Input of 19

19b Input of 19

19c Output of 19

21 Drive gate

22 Two-position gate

23 Flow rate regulator

24 Flow rate regulator

25 Check valve

1. Hydraulic device comprising,
two hydraulic actuators (1, 2), in particular a motor (2) and a double-acting jack (1), each comprising two couplings (la, 1b, 2a, 2b) for the entry and/or the exit of a control fluid,
two pipes (6, 7) coupled to the two actuators (1, 2) and devised so that one conveys a pressurized fluid to a respective coupling of each actuator whilst the other discharges the fluid to the other respective coupling, and vice versa, in such a way that one of the actuators, in particular the jack (1), can be controlled so as to selectively produce a movement in one direction as well as in a reverse direction, and
a selective reversing gate for reversing between the two pipes (6, 7) the supplying of pressurized fluid and the discharging of the fluid, so as to control the direction of the movement of one of the actuators, in particular of the said jack (1),
the device being characterized in that it comprises:
a means of detection (8) sensitive to a difference in pressure between the pressurized fluid and the discharged fluid, and
between the reversing gate and the other actuator (2), in particular the motor (2), an auxiliary reversing means (9), devised so as to receive a command from the detection means (8) and to automatically couple, as a function of this command, the pipe (6, 7) supplied with pressurized fluid to a same specified coupling (2a) of the other actuator (2), in particular the motor (2).

2. Device according to claim 1, characterized in that the detection means (8) and auxiliary reversing means (9) are combined into a system of four check valves (12) devised so as to open in one direction and close in the other direction of flow of the fluid,
a first (12a) and a second (12b) of the valves being coupled by one of their orifices to a first (6) of the two pipes (6, 7), the first valve (12a) in a passing direction and the second valve (12b) in a blocking direction for the fluid coming from the first pipe (6),
a third (12c) and a fourth (12d) of the valves being coupled by one of their orifices to the second pipe (7), the third valve (12c) in a blocking direction and the fourth valve (12d) in a passing direction for the fluid coming from the second pipe (7),
the first (12a) and the fourth valve (12d) being coupled by their other orifice to a chosen coupling (2a) of the second actuator (2), and
the second (12b) and the third valve (12c) being coupled by their other orifice to the other coupling (2b) of the second actuator (2).

3. Device according to claim 1, characterized in that it comprises,
in the guise of detection means (8), at least one drive gate (15) devised so as to sense the pressure of the pressurized fluid, with respect to that of the discharged fluid, of one of the two pipes (6, 7), and
in the guise of auxiliary reversing means (9), a gate (16) having two positions, a position (16a) for parallel coupling and a position (16b) for crossed coupling of the two pipes (6, 7) to the two couplings (2a, 2b) of the second actuator (2).

4. Device according to claim 1, characterized in that it comprises,
in the guise of detection means (8), a pressure comparator (19) with two inputs (19a, 19b) for a respective pressure signal and with a control output (19c), one input (19a) being coupled to one pipe (6) and the other input (19b) to the other pipe (7), and
in the guise of auxiliary reversing means (9), a gate (16) having two positions, a position (16a) for parallel coupling and a position (16b) for crossed coupling of the two pipes (6, 7) to the two couplings (2a, 2b) for the fluid of the second actuator (2), the output (19c) of the comparator (19) being coupled to the gate (16) so as to control it.

5. Device according to claim 1 or 3, characterized in that it comprises,
in the guise of detection means (8), two drive gates (21) devised so that each senses the pressure of a respective pipe (6, 7) of the two pipes, and
in the guise of auxiliary reversing means (9), a gate (16) having at least two positions, a position (16a) for parallel coupling and a position (16b) for crossed coupling of the two pipes (6, 7) to the two couplings (2a, 2b) of the second actuator (2).

6. Device according to claim 5, characterized in that it comprises, in the guise of auxiliary reversing means (9), a gate comprising a third position in which, when the two drive gates (21) sense a pressure of the same order in their associated pipe (6, 7), the passage of fluid between the two pipes (6, 7) and the second actuator (2) is blocked.

7. Device according to any one of claims 1 to 6, characterized in that
it consists of a rig intended in particular for agricultural, civil engineering or military works,
the reversing gate is a control available to an operator of the rig,
the two actuators (1, 2) are located remotely, in particular at the tip of an articulated arm, the two pipes (6, 7) being installed in reserve mode for controlling an optional accessory which may be mounted at the tip of the said arm.
